(19) United States
(12) Patent Application Publication
(10) Pub. No.: US 2005/0258175 A1
(43) Pub. Date: Nov. 24, 2005

(54) Pull tab and method

(75) Inventor: Gerald Robertson, Scottsdale, AZ (US)

Correspondence Address: WEISS & MOY PC, 4204 NORTH BROWN AVENUE, SCOTTSDALE, AZ, 85251, US

(73) Assignee: ROBERTSON ASSOCIATES LLC

(21) Appl. No.: 11/135,052

(22) Filed: May 23, 2005

Related U.S. Application Data
(60) Provisional application No. 60/573,465, filed on May 21, 2004.

(51) Int. Cl. B65D 17/34; G09F 3/00

(52) U.S. Cl. 220/269; 220/906; 40/306; 40/307; D09/438; D09/518; D07/619.2; D07/623

(57) ABSTRACT

An improved pull tab apparatus and method wherein a pull tab conveying a secondary meaning or message is affixed to a can end. The secondary meaning may be, for example, a sports images, health messages, food items, facial shapes, animated shapes, or political message. For example, it may be desired to provide a pull tab in the shape of a football or race car steering wheel. It may be desired to offer for sale cans having such an apparatus thereon at an event related to the secondary meaning—for example, to sell beer cabs with a football shaped tab at a football game.

### RELATED APPLICATION

This non-provisional application claims priority from Provisional Application No. 60/573,465, filed on May 21, 2004, the disclosure of which is incorporated herein by reference in its entirety.

### BACKGROUND OF THE INVENTION

Cans with pull-tabs are commonly used for soft drinks, beer, and food items. The end of a can having a pull-tab has three components: (a) the can end, also known as the “shell”; (b) the tab; and (c) the rivet, which secures the tab to the shell.

Prior art pull-tab designs are, almost exclusively, purely functional in nature. They utilize a generic tab having a shape that is intended to be relatively easy to grasp and pull. However, the tab itself is not formed in a way that is intended to be particularly pleasing aesthetically, or that conveys a secondary message to the user/potential purchaser that is more than simply a logo/trademark of the company that is selling the product.

Several patents have been issued for tab designs, wherein the tab has been configured to exhibit the logo/trademark of the company selling the product. However, prior art pull-tab designs do not disclose tabs having a design intended to convey a secondary meaning; i.e., to promote something other than the logo/trademark of the product being sold, such as a sporting event, health message, food item, facial shape, etc.

The present invention satisfies these needs and provides other, related, advantages.

### SUMMARY OF THE INVENTION

In accordance with one embodiment of the present invention, an improved pull-tab apparatus is disclosed. The apparatus comprises, in combination: a can end; and a pull tab secured to the can end with a rivet; wherein the pull tab conveys a secondary meaning.

In accordance with another embodiment of the present invention, a method for promoting a secondary message is disclosed. The method comprises: providing a can end; and securing a pull tab to the can end with a rivet; wherein the pull tab conveys a secondary meaning.

In accordance with a further embodiment of the present invention, a method for promoting a secondary message is disclosed. The method comprises: providing a can end; securing a pull tab to the can end with a rivet; wherein the pull tab conveys a secondary meaning; and marketing a can having the pull tab at an event associated with the secondary meaning.

### BRIEF DESCRIPTION OF THE DRAWINGS

FIG. 1 is a top view of a can end consistent with an embodiment of the present invention, illustrating a football-themed tab.

FIG. 2 is a perspective view of the can end of FIG. 1.

FIG. 3 is a top view of a can end consistent with an embodiment of the present invention, illustrating a racing-themed tab.

FIG. 4 is a perspective view of the can end of FIG. 3.

FIG. 5 a top view of a can end consistent with an embodiment of the present invention, illustrating a hockey theme.

FIG. 6 is a perspective view of the can end of FIG. 5

FIG. 7 is a top view of a can end consistent with an embodiment of the present invention, illustrating a racing-themed tab.

FIG. 8 is a perspective view of the can end of FIG. 7.

FIG. 9 is a top view of a can end consistent with an embodiment of the present invention, illustrating a fitness-themed tab.

FIG. 10 is a perspective view of the can end of FIG. 9.

FIG. 11 is a top view of a can end consistent with an embodiment of the present invention, illustrating a tab and can end formed into an image of a face.

FIG. 12 is a perspective view of the can end of FIG. 11.

FIG. 13 is a top view of a can end consistent with an embodiment of the present invention, formed into an image of a clam shell.

FIG. 14 is a perspective view of the can end of FIG. 13.

### DETAILED DESCRIPTION OF THE PREFERRED EMBODIMENTS

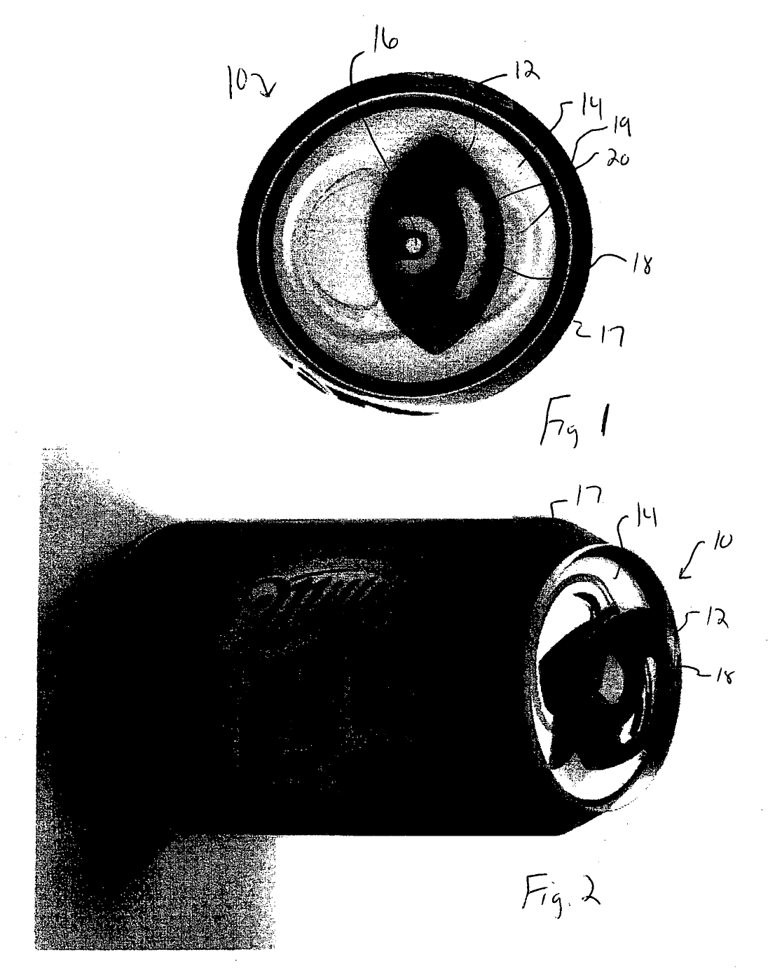

Referring first to FIGS. 1-2, a pull-tab apparatus 10 consistent with an embodiment of the present invention is shown. In this embodiment, a tab 12 having a football shape is affixed to a can end 14 with rivet 16. The apparatus 10 sits atop a can 17 which, in this embodiment, may be a beer can. A gripping area 18 may be provided within the tab 12, to facilitate the gripping of the tab 12 by a user. (It may be desired to provide a serrated surface 19 to a portion of the interior of the gripping area 18, to yet further facilitate gripping.) It may also be desired to provide a recessed area 20 within can end 14, to further facilitate the sliding of a finger by a user under the tab 12 and the gripping thereof.

It can be seen that, in this embodiment, can 17 is a beer can, and that tab 12 has a football theme. It would be desired to offer can 17 for sale at a football game or other football-related event (e.g., football banquet or charity event); during the football season; and/or as part of a football-related promotion.

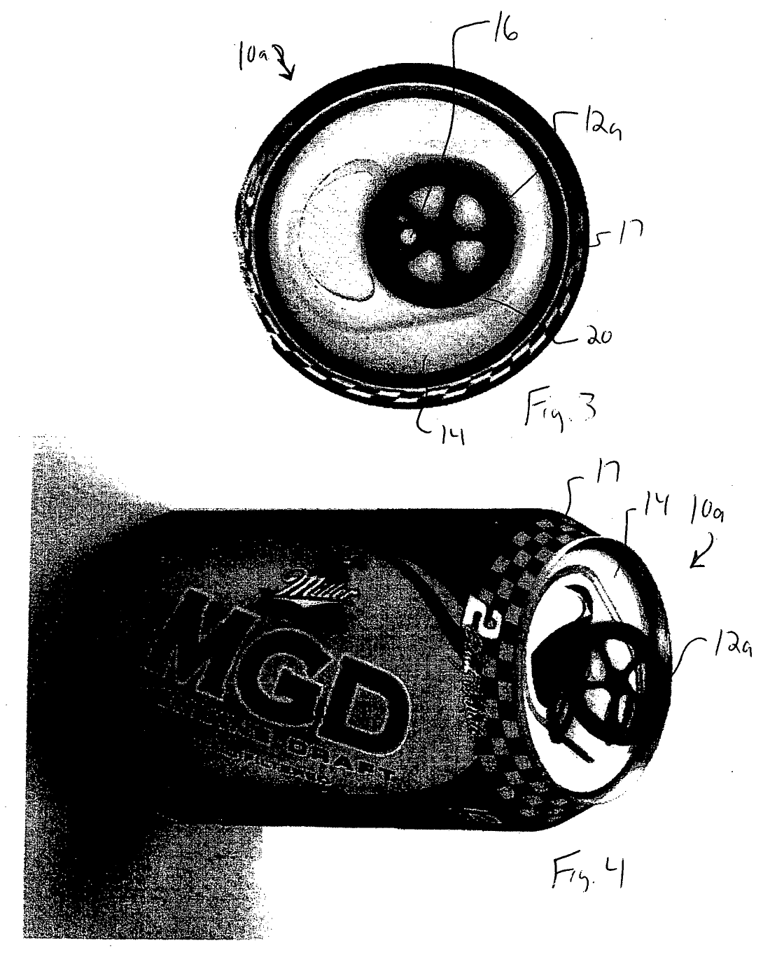

Referring now to FIGS. 3-4, a pull-tab apparatus 10a consistent with an embodiment of the present invention is shown. In this embodiment, a tab 12a having a steering wheel shape is affixed to a can end 14 with rivet 16. The apparatus 10a sits atop a can 17 which, in this embodiment, may be a beer can. It may be desired to provide a recessed area 20 within can end 14, to further facilitate the sliding of a finger by a user under the tab 12a and the gripping thereof.

It can be seen that, in this embodiment, can 17 is a beer can, and that tab 12a has an auto racing theme. It would be desired to offer can 17 for sale at a NASCAR® or other auto racing or auto racing-related event; during the auto racing season; and/or as part of an auto racing-related promotion.

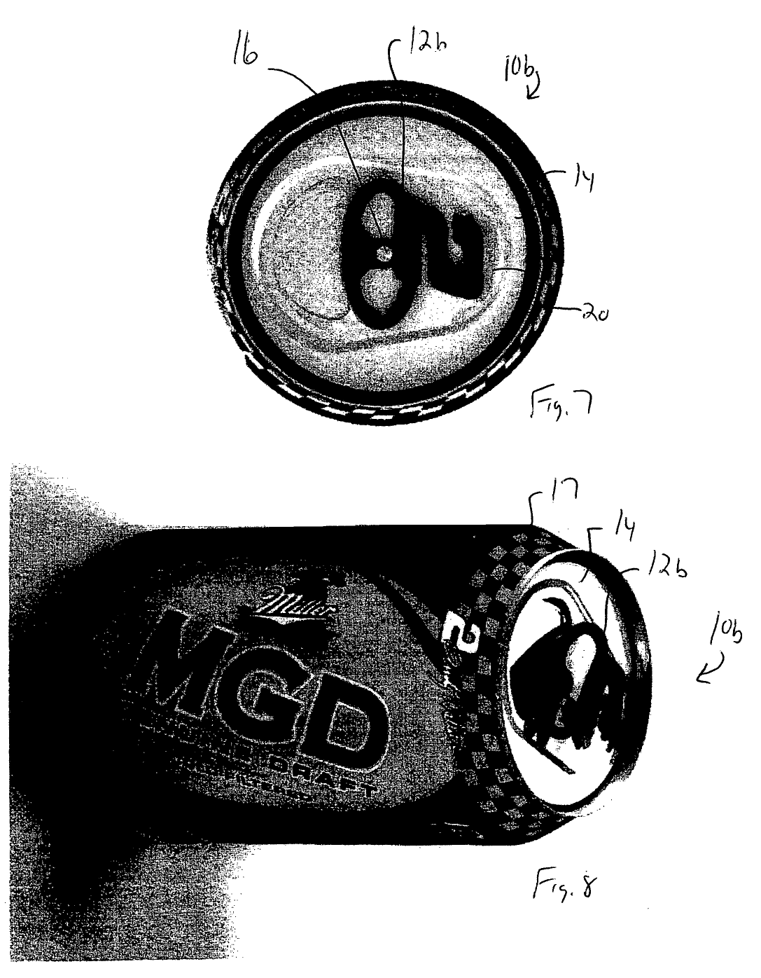

In FIGS. 7-8, pull-tab apparatus 10b includes a tab 12b comprising a combination of a steering wheel and a car number. The tab 12b is affixed to a can end 14 with rivet 16. The apparatus 10b sits atop a can 17 which, in this embodiment, may be a beer can. It may be desired to provide a recessed area 20 within can end 14, to further facilitate the sliding of a finger by a user under the tab 12a and the gripping thereof.

As noted above with respect to FIGS. 3-4, the embodiment of FIGS. 7-8 has an auto racing theme. It would be desired to offer can 17 for sale at a NASCAR® or other auto racing or auto racing-related event; during the auto racing season; and/or as part of an auto racing-related promotion. Moreover, by incorporating into the tab 12b a particular car number, it is further possible to link the promotion of the sale of the can 17 with a particular driver.

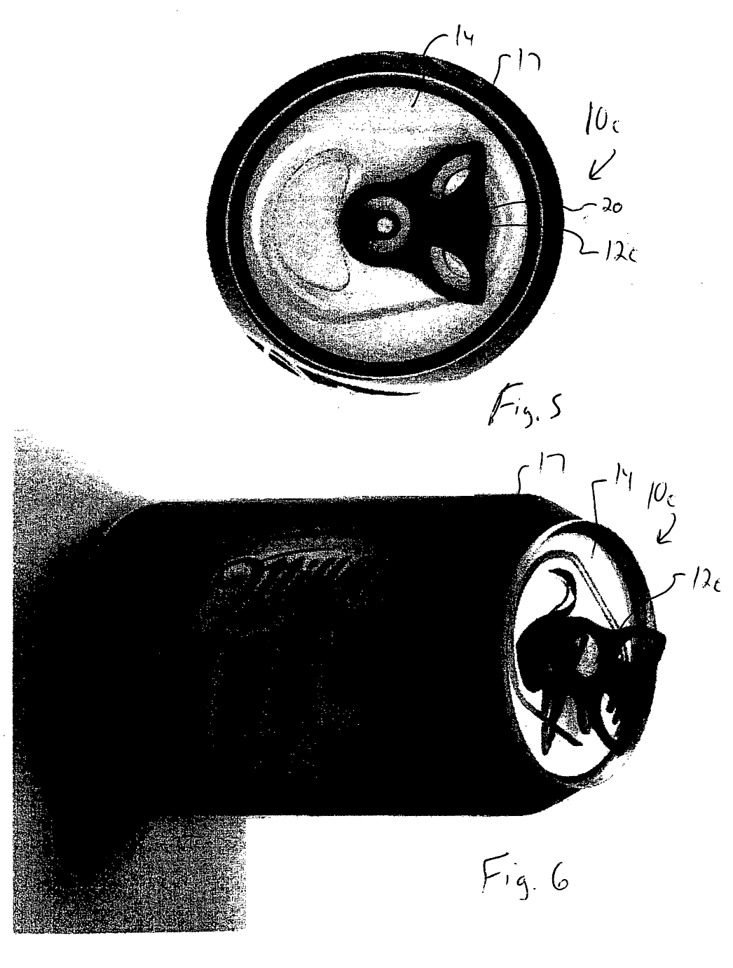

Referring now to FIGS. 5-6, a pull-tab apparatus 10c consistent with an embodiment of the present invention is shown. In this embodiment, a tab 12c having a hockey goalie mask shape is affixed to a can end 14 with rivet 16. The apparatus 10c sits atop a can 17 which, in this embodiment, may be a beer can. It may be desired to provide a recessed area 20 within can end 14, to further facilitate the sliding of a finger by a user under the tab 12c and the gripping thereof.

It can be seen that, in this embodiment, can 17 is a beer can, and that tab 12c has a hockey theme. It would be desired to offer can 17 for sale at a hockey game or hockey-related event; during the hockey season; and/or as part of a hockey-related promotion.

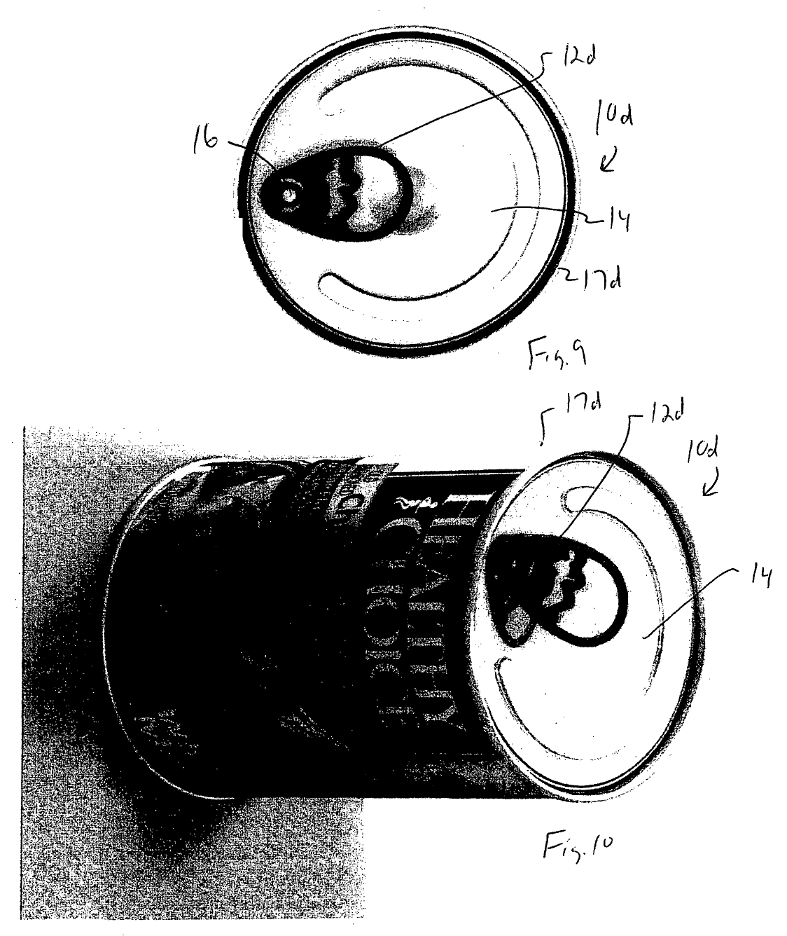

Referring now to FIGS. 9-10, a pull-tab apparatus 10d consistent with an embodiment of the present invention is shown. In this embodiment, a tab 12d having an image of a runner thereon is affixed to a can end 14 with rivet 16. The apparatus 10d sits atop a can 17d which, in this embodiment, may contain a food item marketed to health-conscious consumers.

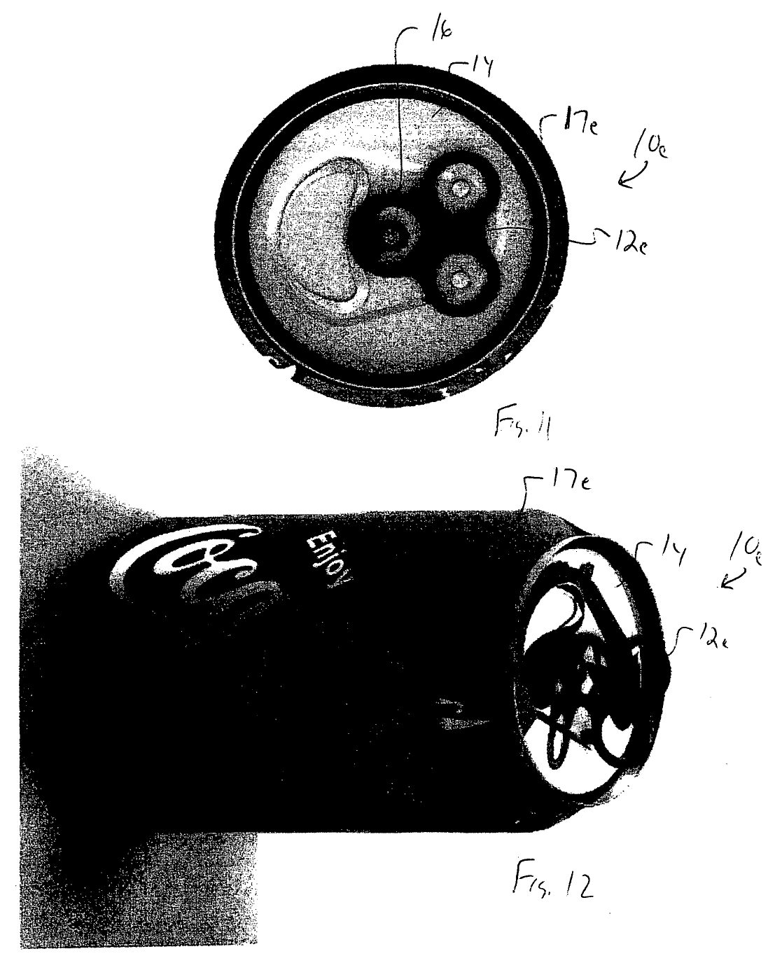

Referring now to FIGS. 11-12, a pull-tab apparatus 10e consistent with an embodiment of the present invention is shown. In this embodiment, a tab 12e having a shape of a nose and two eyes is affixed to a can end 14 with rivet 16. The portion of can end 14 that is to be opened by the lifting of tab 12e is formed into a mouth shape. In addition, rivets 22 may be positioned within the eye portions of the tab 12e, to further convey the image of eyes. It should be noted that apparatus 10e can be formed into a shape of a face of an animated character or famous person, which may be connected to the promotion of sales of the can 17e.

The can 17e may, for example, be offered for sale at a political rally, concert or other event related to a person whose face is portrayed by apparatus 10e—or may be offered for sale in some other venue to benefit that person. Can 17e, in this embodiment, is a soft-drink can.

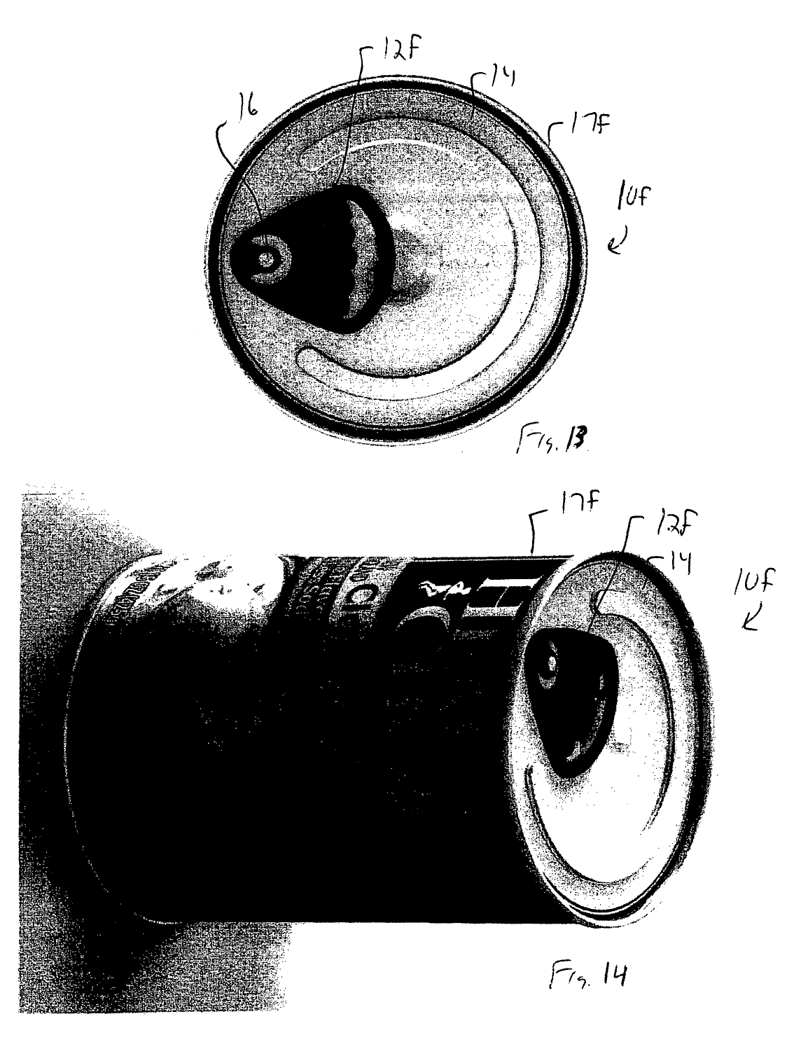

Referring now to FIGS. 13-14, a pull-tab apparatus 10f consistent with an embodiment of the present invention is shown. In this embodiment, a tab 12f having an image of a clam shell is affixed to a can end 14 with rivet 16. The apparatus 10f sits atop a can 17f which, in this embodiment, may contain a clam-related food item.

As noted above, the invention herein may involve business methods, wherein the can having an apparatus consistent with an embodiment of the present invention is marketed in connection with an event and/or person, and where there is a thematic connection between the apparatus and the event/person. It is noted that the term “secondary meaning” or “secondary message,” as used herein or in the claims, means a meaning that relates to something other than the logo/trademark of the product being sold. Examples of secondary meanings or messages include but are not limited to sports images, health messages, food items, facial shapes, animated shapes, political messages, etc.

It should also be noted that the particular tab shapes shown herein are exemplary of those that may contain a secondary meaning. For example, sports images other than footballs, hockey masks, and racing car steering wheels may be utilized—such as baseball images, basketball images, etc. It may be desired to provide political or other messages in the shape of a tab. Other images may conveying a secondary message may also be utilized.

It should be noted that the use of beer cans, soft-drink cans, and food cans is exemplary. Other items sold in cans may also be provided with an apparatus consistent with an embodiment of the present invention. Moreover, with respect to the particular examples provided herein, the particular can type may be varied as desired; e.g., a racing-themed tab may be provided on a soft-drink rather than a beer can, etc.

While the invention has been particularly shown and described with reference to preferred embodiments thereof, it will be understood by those skilled in the art that the foregoing and other changes in form and details may be made therein without departing from the spirit and scope of the invention.

1. An improved pull-tab apparatus comprising, in combination:
a can end; and
a pull tab secured to the can end with a rivet;
wherein the pull tab conveys a secondary meaning.

2. The apparatus of claim 1 wherein the pull tab is in the shape of a sports image.

3. The apparatus of claim 2 wherein the pull tab is in the shape of a steering wheel.

4. The apparatus of claim 2 wherein the pull tab is in the shape of a football.

5. The apparatus of claim 2 wherein the pull tab is in the shape of a goalie mask.

6. The apparatus of claim 1 wherein the pull tab is in the shape of a face.

7. A method for promoting a secondary message comprising:
providing a can end; and
securing a pull tab to the can end with a rivet;
wherein the pull tab conveys a secondary meaning.

8. The method of claim 7 further comprising marketing a can having the pull tab in a manner so as to promote the secondary meaning.

9. The method of claim 8 wherein the secondary meaning is football and the can is marketed in connection with football.

10. The method of claim 9 wherein the can is sold at a football event.

11. The method of claim 10 wherein the football event is a football game.

12. The method of claim 8 wherein the secondary meaning is auto racing and the can is marketed in connection with auto racing.

13. The method of claim 12 wherein the can is sold at an auto racing event.

14. The method of claim 13 wherein the auto racing event is an auto race.

15. A method for promoting a secondary message comprising:
providing a can end;
securing a pull tab to the can end with a rivet;
wherein the pull tab conveys a secondary meaning; and
marketing a can having the pull tab at an event associated with the secondary meaning.

16. The method of claim 15 wherein the event is an auto race.

17. The method of claim 15 wherein the event is a football game.

18. The method of claim 15 wherein the event is a hockey game.
